(19) United States
(12) Patent Application Publication
(10) Pub. No.: US 2021/0008444 A1
(43) Pub. Date: Jan. 14, 2021

(54) CONNECTED ENTERTAINMENT DEVICE

(71) Applicant: Marmium LTD, Hadera (IL)

(72) Inventors: Mor ALON, Hadera (IL); Ronen MELNIK, Hadera (IL)

(21) Appl. No.: 16/981,665

(22) PCT Filed: Mar. 18, 2019
(86) PCT No.: PCT/US2019/022829

§ 371 Date: Sep. 16, 2020

Related U.S. Application Data
(60) Provisional application No. 62/644,150, filed on Mar. 16, 2018.

(51) Int. Cl. A63F 13/216; A63F 13/213; A63F 13/428; A63F 13/837; A63F 13/92

(52) U.S. Cl. CPC A63F 13/216; A63F 13/213; A63F 2300/10; A63F 13/837; A63F 13/92; A63F 13/428

(57) ABSTRACT

Systems and methods are disclosed for connected entertainment devices. In one implementation, location identifier(s) are received from a first device and processed to identify biometric identifier(s) associated with users determined to be present within a defined proximity of the first device. The identified biometric identifier(s) are provided to the first device. An action notification is received from the first device, the action notification including location identifier(s) associated with the first device, input(s) originating from sensor(s) of the first device, and an identifier associated with a target of the action. The action notification is processed in relation to location identifier(s) associated with the target of the action to determine a result of the action. Operations are initiated based on the result of the action.

### CROSS-REFERENCE TO RELATED APPLICATION

This application is related to and claims the benefit of U.S. Patent Application No. 62/644,150, filed Mar. 16, 2018, which is incorporated herein by reference in its entirety.

### TECHNICAL FIELD

Aspects and implementations of the present disclosure relate to connected devices and, more specifically, but without limitation, to connected entertainment devices.

### BACKGROUND

Mobile games are a popular source of entertainment. The features of such games are limited to the functionality of the device the games are played on.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example device, in accordance with an example embodiment.

FIG. 3A is a flow chart illustrating a method, in accordance with example embodiments, for connected entertainment devices.

FIG. 3B is a flow chart illustrating a method, in accordance with example embodiments, for connected entertainment devices.

FIG. 4 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to connected entertainment devices.

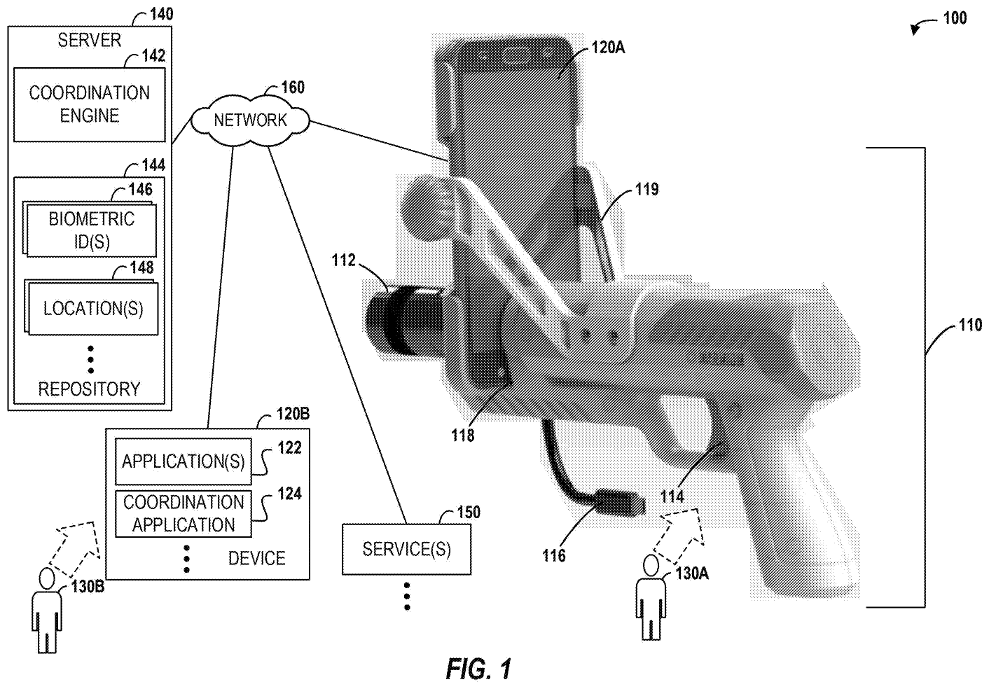

FIG. 1 illustrates an example system 100, in accordance with some implementations. As shown, system 100 includes accessory 110, device 120A and device 120B (collectively, devices 120), server 140, and service(s) 150. These (and other) elements or components can be connected to one another via network 160, which can be a public network (e.g., the Internet), a private network (e.g., a local area network (LAN) or wide area network (WAN)), or a combination thereof. Additionally, in certain implementations various elements may communicate and/or otherwise interface with one another. For example, accessory 110 and device 120A can communicate directly with one another via various communication protocols (e.g., Bluetooth), as described herein.

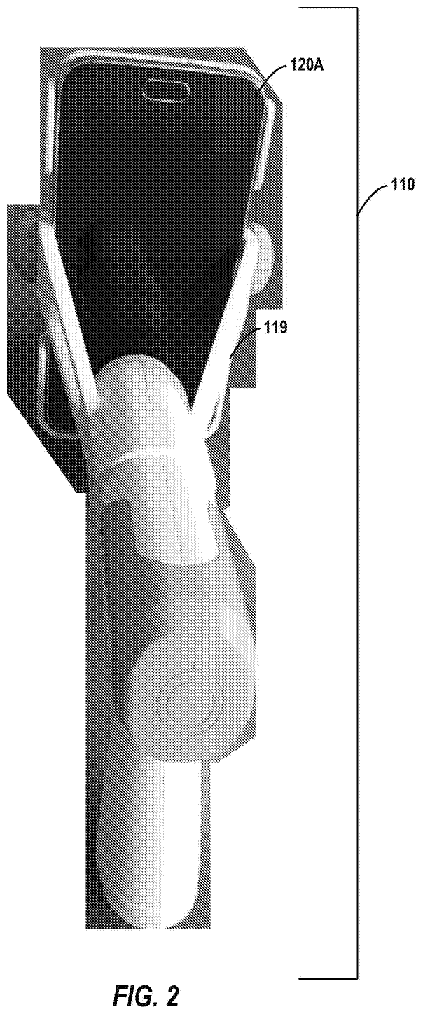

Accessory 110 can be a handheld device or apparatus configured to position device 120A in a particular orientation. As shown in FIG. 1 and FIG. 2, in certain implementations accessory 110 can be constructed in the shape of a gun. In other implementations accessory 110 can be constructed in other shapes (e.g., in the shape of another weapon or device).

As shown in FIG. 1, accessory 110 can include or incorporate optical unit 112. Optical unit 112 can be one or more lens(es), such as a 10× (for example) optic telescopic lens. Such an optical unit can be positioned on the accessory 110 such it can align with a camera/sensor of device 120A (e.g., a smartphone). For example, as shown in FIG. 1, device 120A can be inserted into cavity 118 of accessory 110 to enable a camera of device 120A (e.g., a rear-facing camera) to align with optical unit 112. In doing so, device 120A can perceive visual content via optical unit 112 (which may, for example, enable magnification of such content beyond the capabilities of device 120A alone). For example, the operation/gameplay of various associated apps/games may utilize visual content as magnified/perceived via optical unit 112 (which may not otherwise be clearly perceptible using an integrated camera of the device). By way of illustration, in a gameplay scenario the described technologies can be used to determine/depict whether the user ‘hit’ a distant target, as described herein.

Accessory 110 can also include support unit 119. Such a support unit can include various arm(s) and/or other components configured to hold or stabilize device 120A. In certain implementations, support unit 119 may be constructed to the specifications of certain device(s) (e.g., based on the size/shape of such devices, accounting for the position of the camera or other sensors within such devices, etc.). In other implementations, support unit 119 may be adjustable, such that devices having different dimensions, configurations, etc., can utilize accessory 110. For example, support unit 119 can include adjustable arms that can be sized to securely hold devices having different dimensions/configurations (e.g., having cameras/sensors in different positions).

As shown in FIG. 1, accessory 110 can also include trigger 114. Trigger 114 can be a button or any other such device or component through which input or feedback can be provided (e.g., by a human user). In certain implementations, when trigger 114 is activated or depressed, accessory 110 can transmit or provide various instructions or commands to device 120A (e.g., via Bluetooth or another communication interface). It should be understood that trigger 114 may include or integrate various sensors that are connected to a circuit board (not shown) that may further include various communication elements (e.g., transmitters, receivers, etc.). In doing so, accessory 110 can provide commands that can be transmitted to and processed/executed by device 120A.

Accessory 110 can also include various internal components such as a battery (which may be charged via cable 116) circuit board(s), processors, sensors, and/or other components such as those described in detail with respect to device(s) 120. In certain implementations, the accessory can be associated with a unique serial number (e.g., to unlock app gun features and ensure genuine products are being used in conjunction with the described application).

Each of the referenced device(s) 120 can be, for example, a computing device such as a mobile phone, smartphone, tablet device, wearable device, etc. In other implementations, such device(s) can include personal computers (PCs), a virtual reality device, an augmented reality device, a holographic device, and the like.

In certain implementations, accessory 110 can be connected to and/or otherwise configured to communicate with device 120 via various communication interfaces (e.g., Bluetooth). For example, by activating trigger 114, a command can be transmitted to device 120 (e.g., a ‘fire’ command or instruction in relation to a game executing on the device).

User 130A and user 130B (collectively, users 130) can be human users who interact with devices such as device 120A and device 120B, respectively (e.g., in conjunction with the referenced accessory 110). For example, user 130A can provide various direct or indirect inputs (e.g., via accessory 110 and/or an input device/interface such as a keyboard, mouse, touchscreen, microphone—e.g., for voice/audio inputs, etc.) to device 120A. Device 120A can also display, project, and/or otherwise provide content to user 130A (e.g., via output components such as a screen, speaker, etc.). For example, a display of device 120A can be configured to present or depict visual content, images, etc. captured by a camera of the device via optical unit 112. For example, such content can reflect magnified or ‘zoomed in’ images/video captured by the camera via the optical unit. In certain implementations, a user may utilize multiple devices, and such devices may also be configured to operate in connection with one another (e.g., a smartphone and a smartwatch)

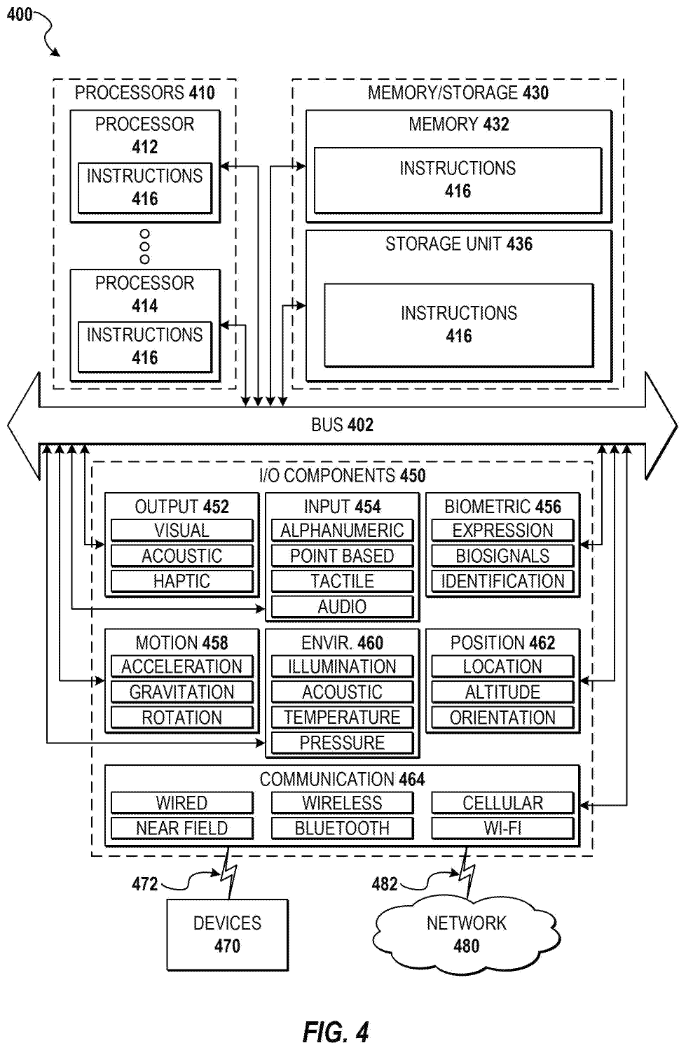

Device(s) 120 can also store and/or execute various applications, games, etc. For example, device 120 can also include one or more application(s) 122 and coordination application 124. Each of application(s) 122 and coordination application 124 can be programs, modules, or other executable instructions that configure/enable the device to interact with, provide content to, and/or otherwise perform operations on behalf of a user. In certain implementations, such applications can be stored in memory of device 120 (e.g. memory 430 as depicted in FIG. 4 and described below). One or more processor(s) of device 120 (e.g., processors 410 as depicted in FIG. 4 and described below) can execute such application(s). In doing so, device 120 can be configured to perform various operations, present content to user 130, etc.

For example, application(s) 122 and/or coordination application 124 can include a game, ‘app,’ or other such instructions that can enable the device 120 to process visual content, images, etc., perceived by the device (e.g., via optical unit 112) in conjunction with inputs or feedback provided by the accessory (e.g., activation of trigger 114, corresponding to a ‘fire’ command). In doing so, the referenced application, game, etc., can perform various determinations, e.g., to determine a result of the referenced input/activation (e.g., whether such a command resulted in a ‘hit’ or ‘miss’ of a target, such as another player within the game), as described in detail herein.

Additionally, in certain implementations the referenced app or game can be configured to process visual content as magnified/perceived via optical unit 112. For example, a game can be configured to identify various targets (e.g., items, other users, etc.) that may only be distinguishable/recognizable via optical unit 112 (e.g., based on the distance to the target). Accordingly, the described technologies can provide an enhanced gameplay experience by presenting magnified visual content (e.g., on the display of device 120) and further configuring functionality of the referenced game/app in relation to such magnified content.

By way of illustration, the application/game can present the referenced magnified visual content with a ‘crosshairs’ overlay. Activation of the trigger in relation to the position of the crosshairs with respect to the visual content (which may not otherwise be clearly perceptible using the integrated camera of the device 120 alone) can be used to determine whether the user hit a target (and/or enhance other aspects of the gameplay).

In one example implementation, by configuring accessory 110 with device 120, a user can be provided with an exciting gaming screen/interface (e.g., via a display for device 120) integrated within a gaming device that, for example: makes firing sounds, indicates whether the enemy was hit, indicates whether the user was hit by other players, keeps individual and group game scores (bullets fired, injuries sustained and inflicted, etc.) and keeps the group engaged. In certain implementations, such additional game features enabled by the app include: range of weapon, weapon type, sounds, accuracy, graphics, league tables, etc.

Various aspects of the described technologies can utilize inputs originating from various sensors of the device 120. Examples of such inputs include but are not limited to: visual content originating from a camera of the device, inputs from motion sensors of the device, location inputs (e.g., from a GPS receiver), etc. Such inputs can reflect, for example, various aspects of the activity of a user when playing a game (e.g., where the user is located, what the user is doing while playing, etc.). By further coordinating gameplay with other users (e.g., via a server, as described herein), the described technologies can, for example, transform a neighborhood and a group of gathered friends into an exciting gaming experience.

Additional features of the described technologies can include utilization of face recognition technology (e.g., to identify participants), efficient utilization of bandwidth to create spontaneous effects, server-side capabilities to manage millions of simultaneous multi-player games, etc.

It should be noted that while application(s) 122 and 124 are depicted and/or described as operating on a device 120, this is only for the sake of clarity. However, in other implementations such elements can also be implemented on other devices/machines. For example, in lieu of executing locally at device 120, aspects of application(s) 122 and 124 can be implemented remotely (e.g., on a server device or within a cloud service or framework).

Device 120A can be further configured to communicate with other devices, e.g., via network 160. For example, inputs, commands, determinations, etc., originating from device 120A and/or accessory 110 can be transmitted to server 140 via network 160. Server 140 can be a rackmount server, a personal computer, a mobile device, or any other such computing device capable of implementing the various features described herein. Server 140 can include components such as coordination engine 142 and data repository 144. In certain implementations, server 140 can also include and/or incorporate various sensors and/or communications interfaces (including but not limited to those depicted and described in relation to device(s) 120. The components can be combined together or separated in further components, according to a particular implementation. Additionally, in some implementations, various components of server 120 may run on separate machines. Some operations of certain of the components are described in more detail herein.

As shown in FIG. 1, server 140 can include coordination engine 142. Coordination engine 142 can be, for example, an application, module, instructions, etc., executed and/or otherwise implemented by server 140 that enables the real-time deployment of multiplayer games and/or other such activities. For example, inputs, commands, etc., can be received from device 120A and/or other device(s) 120B, etc., (which may be devices located within a defined proximity from device 120A). Coordination engine 142 can further maintain the status of various participants within a game or activity (e.g., a score achieved by a player, a player's status—e.g., whether the player has been ‘hit,’ etc.).

Repository 144 can be hosted by one or more storage devices, such as main memory, magnetic or optical storage based disks, tapes or hard drives, NAS, SAN, and so forth. In some implementations, repository 144 can be a network-attached file server, while in other implementations repository 144 can be some other type of persistent storage such as an object-oriented database, a relational database, and so forth, that may be hosted by the server 140 or one or more different machines coupled to server 140 via the network 160, while in yet other implementations repository 144 may be a database that is hosted by another entity and made accessible to server 140. In other implementations, repository 144 can be implemented as within a distributed or decentralized system/environment (e.g., using blockchain and/or other such distributed computing/storage technologies).

In certain implementations, repository 144 can store data pertaining to and/or otherwise associated with various users, locations, and/or other information. In certain implementations, such stored information can pertain to aspects of various games (e.g., multiplayer games) coordinated by server 140 with respect to players that participate via their respective accessories 110 and/or devices 120. For example, repository 144 can store identifying information such as biometric identifier(s) (“IDs”) 146. Such identifiers 146 can include but are not limited to image(s) reflecting the face and/or body of a user, and/or other such physical and/or detectable characteristics (e.g., fingerprint, retina information, etc.). As described herein, such identifiers can be utilized to identify/associate various gameplay occurrences with the users/participants to which they occur.

Additionally, in certain implementations repository 144 can store various location identifier(s) 148 and/or other such information (e.g., real-time information). Such location(s) can pertain to the historical and/or current location of a player of the referenced game(s) and/or a device/accessory associated with such a player. In certain implementations, such locations can be determined based on inputs (e.g., location coordinates) originating from a GPS receiver of a device 120. As described herein, such locations can be utilized to enable various gameplay functionality/operations.

In certain implementations, server 140 and/or coordination engine 142 can further communicate or interface with service(s) 150. Services 150 can be, for example, third party services, applications, etc., that utilize various features or functionality described herein (e.g., to coordinate other games, activities, etc., among the referenced devices/participants).

In one example implementations, the described technologies can enable a group of 2-6 players to meet. One player is the “organizer” who sets up an ad-hoc group within the app. The organizer can take pictures of each player's upper body (e.g., to compile as a reference profile for the game, using visual elements such as clothes, color scheme, etc.). The group can set a realm/theme which influences sounds, gun site appearance of players, etc. The group can further select a “level” playing field or individual skill level in which each player brings his accumulated capabilities and game assets. The described technologies enable users to play, keep score, communicate, etc., as described herein. Additionally, in certain implementations the described technologies can enable individual missions to earn points and advance in rating. Additionally, in certain implementations various daily missions, etc., can be coordinated. For example, challenges where a user can be recognized for ‘hits’ on: people, things (e.g. clock, mail boxes on the street, etc.), animals (crows, pigeons, etc.), training on paper targets, etc. Additionally, user groups can be formed and can define their own “targets,” e.g., by uploading target pictures.

It should be noted that while various components are depicted and/or described as operating on a device (e.g., server 140), this is only for the sake of clarity. However, in other implementations the referenced components can also be implemented on other devices/machines. For example, in lieu of executing locally at server 140, aspects of coordination engine 142 can be implemented across multiple devices within a cloud service or framework).

While many of the examples described herein are illustrated with respect to a single server or device, this is simply for the sake of clarity and brevity. However, it should be understood that the described technologies can also be implemented (in any number of configurations) across multiple servers and/or other computing devices/services.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

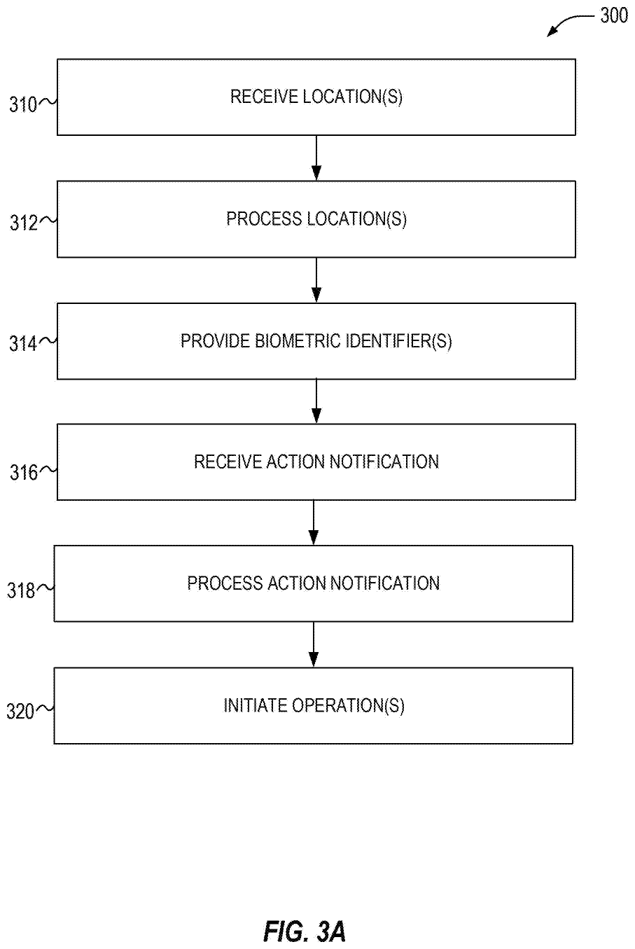

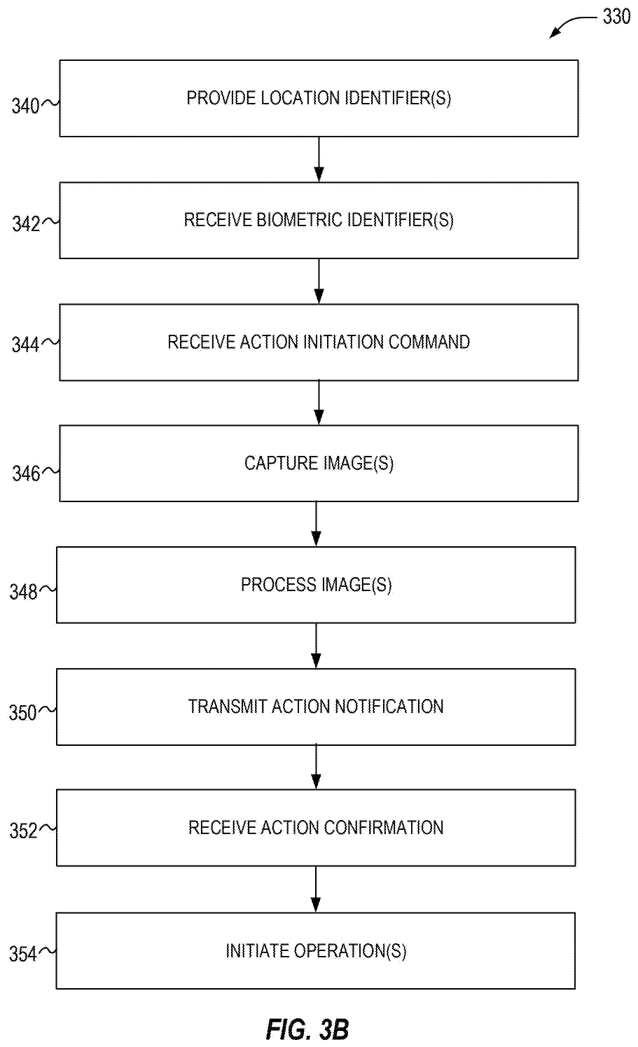

FIG. 3A is a flow chart illustrating a method 300, according to an example embodiment, for connected entertainment devices. The method is performed by processing logic that can comprise hardware (circuitry, dedicated logic, etc.), software (such as is run on a computing device such as those described herein), or a combination of both. In one implementation, the method 300 is performed by one or more elements depicted and/or described in relation to FIG. 1 (including but not limited to server 140, coordination engine 142, device(s) 120 and/or coordination application 124), while in some other implementations, the one or more blocks of FIG. 3A can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, one or more location identifiers can be received. In certain implementations, such identifiers can be received (e.g., at server 140) from a first device (e.g., device 120A as shown in FIG. 1). Such location identifier(s) can reflect, for example, the current geographic location of the device and/or user 130A.

At operation 312, the one or more location identifiers (e.g., those received at 310) are processed. In doing so, one or more biometric identifiers 146 can be identified. Such biometric identifiers can be identified from within repository 144. As described herein, such biometric identifiers may be associated with certain other users (e.g., participants in a gaming network/platform). Additionally, such biometric identifiers can be associated with respective geographic locations that can reflect, for example, the current location of the user associated with such biometric identifier. Based on such location 148 (as stored in repository 148), the described technologies (e.g., server 140 and/or coordination engine 142) can determine which users are present/located within a defined proximity (e.g., 100 meters) of the first device. Those users determined to be within the referenced proximity can be identified as being potential candidates to engage in various multi-player games with the referenced used. Accordingly, the stored biometric identifiers associated with such users can be identified.

As described herein, the referenced biometric identifiers include but are not limited to various visual content that reflects visual characteristic(s) of the referenced users, such as images of the face, body, etc., and/or other identifying characteristics of such users.

At operation 314, the identified biometric identifier(s) (e.g., as identified at operation 312) are provided to the first device (e.g., device 120A as shown in FIG. 1). In doing so, the device can be ‘pre-loaded’ with identifying information associated with various users/players determined to be present nearby. Accordingly, the device 120 can perform various processing operations, including facial recognition operations, even without further communication with server 140.

At operation 316, an action notification is received, e.g., from the first device. Such an action notification can include, for example, one or more location identifiers associated with the first device (reflecting, for example, the current location of the device 120A), one or more inputs originating from one or more sensors of the first device (e.g., compass, accelerometer, etc.), and an identifier associated with a target of the action (e.g., a user identifier that reflects a user/participant determined—e.g., by device 120A, coordination application 124, etc.—to be the target of an action, such as a ‘shot’ in a game involving shooting).

In certain implementations, the referenced action notification can be generated at the first device (e.g., device 120A) in response to an action initiation command originating from an accessory (e.g., accessory 110). For example, such an action initiation command can be a command generated/provided by the accessory in response to an activation of the trigger by a user, as described in detail herein.

As noted, in certain implementations the referenced inputs originating from the one or more sensors of the first device can include directional inputs (e.g., originating from a compass), motion inputs (e.g., originating from an accelerometer), and/or other such inputs originating from other sensors of the device.

At operation 318, the action notification (e.g., as received at operation 316) can be processed. In certain implementations, the action notification can be processed in relation to one or more location identifiers associated with the target of the action. In doing so, a result of the action can be determined.

In certain implementations, the identifier associated with the target of the action can be determined (e.g., at the first device) based on (a) visual content captured by the first device and (b) the identified one or more biometric identifiers provided to the first device. For example, in order to identify a player that a user has ‘shot’ during a shooting game, image(s) captured by device 120A (e.g., when the trigger of accessory 110 was activated) can be processed (e.g., using facial recognition techniques) to identify, based on the previously provided biometric identifiers (e.g., headshot images of other players within a defined proximity) the identity of the player that was ‘shot’ (the ‘target of the action’ referenced above).

In certain implementations, a viability of the action can be determined, e.g., with respect to the target of the action. For example, it can be appreciated that various ‘false positive’ scenarios may arise due to the imperfect nature of facial recognition techniques. By way of illustration, utilizing facial recognition in certain scenarios may lead to two players who look similar to be incorrectly ascribed certain events (e.g., by misidentifying one user as the other and incorrectly ascribing a ‘hit’ to such user). Accordingly, upon identifying a target user associated with an action (e.g., a user that was ‘hit’ by a ‘shot’ of another user), further verification techniques can be utilized to verify the viability of such an action. For example, upon determining that the identified ‘target’ user was actually in another location, such an action can be determined not be accurate with respect to the initially identified user. By way of further example, upon determining that the initiating (e.g., ‘shooting’) user was facing a direction that does not enable a ‘shot’ towards the identified ‘target’ user, such an action can be determined not be accurate with respect to the initially identified user (and subsequent operations, etc., associated with such identification can be prevented). Doing so can substantially improve gameplay experiences for users by ensuring that only verified actions are completed, while preventing ‘false positives’ that might otherwise arise when relying on facial recognition alone.

At operation 320, one or more operations are initiated. In certain implementations, such operations are initiated based on the result of the action (e.g., as determined at 318). For example, visual content can be generated/provided for presentation at a display of the first device (e.g., as a notification, gameplay adjustment, etc.). In other implementations, various other gameplay operations can be initiated (e.g., with respect to any number of devices), such as are described herein.

FIG. 3B is a flow chart illustrating a method 330, according to an example embodiment, for connected entertainment devices. The method is performed by processing logic that can comprise hardware (circuitry, dedicated logic, etc.), software (such as is run on a computing device such as those described herein), or a combination of both. In one implementation, the method 330 is performed by one or more elements depicted and/or described in relation to FIG. 1 (including but not limited to device(s) 120 and/or coordination application 124, server 140, and/or coordination engine 142), while in some other implementations, the one or more blocks of FIG. 3B can be performed by another machine or machines.

At operation 340, one or more location identifiers associated with a first device are provided. For example, device 120A as shown in FIG. 1 can provide its current location/geographic coordinates to server 140.

At operation 342, one or more biometric identifiers are received (e.g., from server 140). As described herein, such biometric identifiers may be associated with certain other users (e.g., participants in a gaming network/platform) and may include but are not limited to various visual content that reflects visual characteristic(s) of the referenced users, such as images of the face, body, etc., and/or other identifying characteristics of such users.

In certain implementations, such biometric identifiers can be received in response to the one or more location identifiers (e.g., as provided at operation 340). For example, as described herein, the referenced biometric identifiers can be associated with users determined to be present within a defined proximity of the first device. Additionally, such biometric identifiers can be associated with respective geographic locations that can reflect, for example, the current location of the user associated with such biometric identifier. Based on such location 148 (as stored in repository 148), the described technologies (e.g., server 140 and/or coordination engine 142) can determine which users are present/located within a defined proximity (e.g., 100 meters) of the first device. Those users determined to be within the referenced proximity can be identified as being potential candidates to engage in various multi-player games with the referenced used. Accordingly, the stored biometric identifiers associated with such users can be identified and provided (e.g., to device 120A).

At operation 344, an action initiation command is received. In certain implementations, such a command can be received from an accessory configured with respect to the first device (e.g., accessory 110 configured with respect to device 120A). An example of such a command is the activation of a trigger of the referenced accessory, as described in detail herein.

At operation 346, one or more images are captured. In certain implementations, such images are captured in response to the action initiation command (e.g., at 344). Additionally, in certain implementations such images (and/or other visual content) can be captured via a camera/optical sensor of the first device as configured in relation to an optical unit 112 of the accessory 110, as described in detail herein.

At operation 348, the one or more images (e.g., those captured at operation 346) are processed. In certain implementations, such images are processed in relation to the received one or more biometric identifiers (e.g., headshot images of game players located near the user). In doing so, a result of an action can be determined.

By way of illustration, in certain implementations the referenced captured images can be processed in relation to the received one or more biometric identifiers (e.g. as received at 342). In doing so, a target of the action can be determined.

In certain implementations, the identifier associated with the target of the action can be determined (e.g., at the first device) based on (a) visual content captured by the first device and (b) the identified one or more biometric identifiers provided to the first device. For example, in order to identify a player that a user has ‘shot’ during a shooting game, image(s) captured by device 120A (e.g., when the trigger of accessory 110 was activated) can be processed (e.g., using facial recognition techniques) to identify, based on the previously provided biometric identifiers (e.g., headshot images of other players within a defined proximity) the identity of the player that was ‘shot’ (the ‘target of the action’ referenced above).

At operation 350, an action notification is transmitted (e.g., to server 140), in certain implementations, such an action notification is transmitted based on the result (e.g. the result of an action determined at 348).

In certain implementations, the referenced action notification can include one or more location identifiers associated with the first device, one or more inputs originating from one or more sensors of the first device (e.g., directional inputs, motion inputs, etc.), and an identifier associated with a target of the action. For example, as described in detail herein, the referenced action notification can include, for example, one or more location identifiers associated with the first device (reflecting, for example, the current location of the device 120A), one or more inputs originating from one or more sensors of the first device (e.g., compass, accelerometer, etc.), and an identifier associated with a target of the action (e.g., a user identifier that reflects a user/participant determined—e.g., by device 120A, coordination application 124, etc.—to be the target of an action, such as a ‘shot’ in a game involving shooting).

At operation 352, an action confirmation is received, e.g., in response to the action notification. In certain implementations, such an action confirmation can be determined based on a processing of the action notification in relation to one or more location identifiers associated with a target of the action.

For example, as described in detail herein, in certain implementations, such an action confirmation can be determined, e.g., with respect to the target of the action. For example, it can be appreciated that various ‘false positive’ scenarios may arise due to the imperfect nature of facial recognition techniques. By way of illustration, utilizing facial recognition in certain scenarios may lead to two players who look similar to be incorrectly ascribed certain events (e.g., by misidentifying one user as the other and incorrectly ascribing a ‘hit’ to such user). Accordingly, upon identifying a target user associated with an action (e.g., a user that was ‘hit’ by a ‘shot’ of another user), further verification techniques can be utilized to verify the viability of such an action. For example, upon determining that the identified ‘target’ user was actually in another location, such an action can be determined not be accurate with respect to the initially identified user. By way of further example, upon determining that the initiating (e.g., ‘shooting’) user was facing a direction that does not enable a ‘shot’ towards the identified ‘target’ user, such an action can be determined not be accurate with respect to the initially identified user (and subsequent operations, etc., associated with such identification can be prevented). Doing so can substantially improve gameplay experiences for users by ensuring that only verified actions are completed, while preventing ‘false positives’ that might otherwise arise when relying on facial recognition alone.

At operation 354, one or more operations are initiated, e.g., based on the action confirmation (e.g., as determined at 352). For example, visual content can be generated/provided for presentation at a display of the first device (e.g., as a notification, gameplay adjustment, etc.). In other implementations, various other gameplay operations can be initiated (e.g., with respect to any number of devices), such as are described herein.

It can therefore be appreciated that the described technologies are directed to and address specific technical challenges and longstanding deficiencies in multiple technical areas, including but not limited to connected devices, gaming, and distributed computing. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

It should also be noted that while the technologies described herein are illustrated primarily with respect to connected entertainment devices, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a processor or other programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described and depicted herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 4 is a block diagram illustrating components of a machine 400, according to some example implementations, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein can be executed. The instructions 416 transform the machine into a particular machine programmed to carry out the described and illustrated functions in the manner described. In alternative implementations, the machine 400 operates as a standalone device or can be coupled (e.g., networked) to other machines. In a networked deployment, the machine 400 can operate in the capacity of a server machine or a client machine in a server-client network environment, or as a peer machine in a peer-to-peer (or distributed) network environment. The machine 400 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 can include processors 410, memory/storage 430, and I/O components 450, which can be configured to communicate with each other such as via a bus 402. In an example implementation, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 412 and a processor 414 that can execute the instructions 416. The term “processor” is intended to include multi-core processors that can comprise two or more independent processors (sometimes referred to as “cores”) that can execute instructions contemporaneously. Although FIG. 4 shows multiple processors 410, the machine 400 can include a single processor with a single core, a single processor with multiple cores (e.g., a multi-core processor), multiple processors with a single core, multiple processors with multiples cores, or any combination thereof.

The memory/storage 430 can include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 can also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 can include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 can include many other components that are not shown in FIG. 4. The I/O components 450 are grouped according to functionality merely for simplifying the following discussion and the grouping is in no way limiting. In various example implementations, the I/O components 450 can include output components 452 and input components 454. The output components 452 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 450 can include biometric components 456, motion components 458, environmental components 460, or position components 462, among a wide array of other components. For example, the biometric components 456 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 can include acceleration sensor components (e.g., accelerometer), gravitation sensor components, rotation sensor components (e.g., gyroscope), and so forth. The environmental components 460 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 462 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 450 can include communication components 464 operable to couple the machine 400 to a network 480 or devices 470 via a coupling 482 and a coupling 472, respectively. For example, the communication components 464 can include a network interface component or other suitable device to interface with the network 480. In further examples, the communication components 464 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 can be another machine or any of a wide variety of peripheral devices (e.g., a peripheral device coupled via a USB).

Moreover, the communication components 464 can detect identifiers or include components operable to detect identifiers. For example, the communication components 464 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 464, such as location via Internet Protocol (IP) geolocation, location via Wi-Fi® signal triangulation, location via detecting an NFC beacon signal that can indicate a particular location, and so forth.

In various example implementations, one or more portions of the network 480 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 can include a wireless or cellular network and the coupling 482 can be a Code Division Multiple Access (CDMA) connection, a Global System for Mobile communications (GSM) connection, or another type of cellular or wireless coupling. In this example, the coupling 482 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 4G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 can be transmitted or received over the network 480 using a transmission medium via a network interface device (e.g., a network interface component included in the communication components 464) and utilizing any one of a number of well-known transfer protocols (e.g., HTTP). Similarly, the instructions 416 can be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving, from a first device, one or more location identifiers;
processing the one or more location identifiers to identify one or more biometric identifiers associated with users determined to be present within a defined proximity of the first device;
providing the identified one or more biometric identifiers to the first device;
receiving an action notification from the first device, the action notification comprising one or more location identifiers associated with the first device, one or more inputs originating from one or more sensors of the first device, and an identifier associated with a target of the action;
processing the action notification in relation to one or more location identifiers associated with the target of the action to determine a result of the action; and
initiating one or more operations based on the result of the action.

2. The system of claim 1, wherein the one or more biometric identifiers comprises visual content that reflects one or more visual characteristics of at least one of the users.

3. The system of claim 1, wherein the action notification is generated at the first device in response to an action initiation command originating from an accessory.

4. The system of claim 1, wherein the one or more inputs originating from the one or more sensors of the first device comprises one or more directional inputs.

5. The system of claim 1, wherein the one or more inputs originating from the one or more sensors of the first device comprises one or more motion inputs.

6. The system of claim 1, wherein the identifier associated with the target of the action is determined at the first device based on visual content captured by the first device and the identified one or more biometric identifiers provided to the first device.

7. The system of claim 1, wherein processing the action notification in relation to one or more location identifiers associated with the target of the action comprises determining a viability of the action with respect to the target of the action.

8. The system of claim 1, wherein initiating one or more operations comprises providing visual content for presentation at a display of the first device.

9. A method comprising:
receiving, from a first device, one or more location identifiers;
processing the one or more location identifiers to identify visual content associated with users determined to be present within a defined proximity of the first device;
providing the identified visual content to the first device;
receiving an action notification generated at the first device in response to an action initiation command originating from an accessory, the action notification comprising one or more location identifiers associated with the first device, one or more inputs originating from one or more sensors of the first device, and an identifier associated with a target of the action determined at the first device based on visual content captured by the first device and the identified visual content provided to the first device;
processing the action notification in relation to one or more location identifiers associated with the target of the action to determine a viability of the action with respect to the target of the action; and
initiating one or more operations based on the viability of the action.

10. A non-transitory computer readable medium having instructions stored thereon that, when executed by a processing device, cause the processing device to perform operations comprising:
providing one or more location identifiers associated with a first device;
receiving, in response to the one or more location identifiers, one or more biometric identifiers;
receiving an action initiation command from an accessory configured with respect to the first device;
capturing one or more images in response to the action initiation command;
processing the one or more images in relation to the received one or more biometric identifiers to determine a result of an action;
based on the result, transmitting an action notification;
receiving, in response to the action notification, an action confirmation; and
initiating one or more operations based on the action confirmation.

11. The non-transitory computer readable medium of claim 10, wherein the one or more biometric identifiers are associated with users determined to be present within a defined proximity of the first device.

12. The non-transitory computer readable medium of claim 10, wherein the one or more biometric identifiers comprises visual content that reflects one or more visual characteristics of one or more users.

13. The non-transitory computer readable medium of claim 10, wherein capturing one or more images comprises capturing one or more images via an optical sensor of the first device as configured in relation to an optical unit of the accessory.

14. The non-transitory computer readable medium of claim 10, wherein processing the one or more images comprises processing the one or more images in relation to the received one or more biometric identifiers to determine a target of the action.

15. The non-transitory computer readable medium of claim 10, wherein the action notification comprises one or more location identifiers associated with the first device, one or more inputs originating from one or more sensors of the first device, and an identifier associated with a target of the action.

16. The non-transitory computer readable medium of claim 15, wherein the one or more inputs originating from the one or more sensors of the first device comprises one or more directional inputs.

17. The non-transitory computer readable medium of claim 15, wherein the one or more inputs originating from the one or more sensors of the first device comprises one or more motion inputs.

18. The non-transitory computer readable medium of claim 10, wherein the action confirmation is determined based on a processing of the action notification in relation to one or more location identifiers associated with a target of the action.

19. The non-transitory computer readable medium of claim 10, wherein initiating one or more operations comprises presenting visual content via a display of the first device.

20. A system comprising:
a processing device; and
a memory coupled to the processing device and storing instructions that, when executed by the processing device, cause the system to perform operations comprising:
providing one or more location identifiers associated with a first device;
receiving, in response to the one or more location identifiers, visual content that reflects one or more visual characteristics associated with users determined to be present within a defined proximity of the first device;
receiving an action initiation command from an accessory configured with respect to the first device;
in response to the action initiation command, capturing one or more images via an optical sensor of the first device as configured in relation to an optical unit of the accessory;
processing the one or more images in relation to the received one or more biometric identifiers to determine a result of an action;
based on the result, transmitting an action notification comprising one or more location identifiers associated with the first device, one or more inputs originating from one or more sensors of the first device, and an identifier associated with a target of the action;
receiving, in response to the action notification, an action confirmation determined based on a processing of the action notification in relation to one or more location identifiers associated with a target of the action; and
initiating one or more operations based on the action confirmation.
